(19) United States
(12) Patent Application Publication
(10) Pub. No.: US 2019/0346344 A1
(43) Pub. Date: Nov. 14, 2019

(54) IMPROVEMENTS IN FLUID SAMPLING

(71) Applicant: Willingdon Properties Pty Ltd, Archerfield (AU)

(72) Inventor: Jarrod Nigel SMITH, Archerfield (AU)

(21) Appl. No.: 16/483,939

(22) PCT Filed: Feb. 7, 2018
(86) PCT No.: PCT/AU2018/050086

§ 371 Date: Aug. 6, 2019

(30) Foreign Application Priority Data
Feb. 7, 2017 (AU) 2017900363

(51) Int. Cl. G01N 1/20; G01N 1/14

(52) U.S. Cl. CPC G01N 1/2035; G01N 2001/205; G01N 1/14

(57) ABSTRACT

A device for sampling a fluid circulating through a system includes: a device inlet; a device outlet; a pressure reducing and/or flow limiting valve or valves between the device inlet and the device outlet for reducing the pressure and/or limiting the flow of the fluid after the fluid enters the device; a flow path altering valve between the pressure reducing and/or the flow limiting valve(s) and the device outlet for receiving the fluid from the pressure reducing and/or flow limiting valve(s) and directing the fluid in a continuous purge flow mode of the device to a first opening of a chamber and through the chamber to the device outlet prior to and after sampling of the fluid: a displacer within the chamber in a continuous purge state when the fluid is directed through the chamber in the continuous purge flow mode; where the flow path altering valve is configured upon activation to change the continuous purge flow mode of the device to a sample discharge flow mode in which the fluid is directed to a second opening of the chamber and through the chamber and the displacer is converted from the continuous purge state to a sample discharged state and the volume of fluid already present in the chamber is discharged through the first opening to obtain a sample of the fluid.

### TECHNICAL FIELD

The present invention relates to fluid sampling. More particularly, the present invention relates to a fluid sampler and a method of sampling a fluid.

### BACKGROUND

Fluid sampling is performed in many industries including oil and gas exploration, mining, and food processing, as well as on vehicles such as cars, trucks, and ships. Sampling may be performed to determine the content of a new fluid or as a quality assurance/quality control measure of a known fluid.

WO 2007/041793 discloses a lubrication fluid sampling station. The station has been marketed under the trademark “Tru-Kleen” and is installed in operative connection with lubrication and coolant fluid recirculation systems used for lubricating, for example, a standing diesel engine powering a generating set. Lubrication fluid is sampled at pressures of up to 125 psi and the sample bottle is subjected to pressure during filling with the fluid. The station also has limited flow control capability.

WO 92/05420 and WO 2004/057306 disclose a fluid sampler that has been marketed under the trademark “DynaSamp” as well as a method for in situ sampling of a fluid. The fluid to be sampled may be pressurised and requires a user to interact closely with the fluid sampler during sampling thereby increasing the risk of the user being exposed to the fluid. The sample bottle is coated in the fluid being sampled leading to handling difficulties. Residual fluid also needs to be relieved and vented which may create an environmental concern.

Therefore, there is a need to provide a solution that allows for efficient sampling of fluids from pressurised fluid systems without compromising the safety of the user.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to fluid sampler, which may at least partially overcome at least one of the abovementioned disadvantages or provide the consumer with a useful or commercial choice.

With the foregoing in view, the present invention in one form, resides broadly in a device for sampling a fluid circulating through a system, the device comprising:

a device inlet through which the fluid enters the device under pressure, and a device outlet;

a pressure reducing and/or flow limiting valve or valves between the device inlet and the device outlet for reducing the pressure and/or limiting the flow of the fluid after the fluid enters the device;

a flow path altering valve between the pressure reducing and/or flow limiting valve(s) and the device outlet, the flow path altering valve being configured for receiving the fluid from the pressure reducing and/or flow limiting valve(s) and directing the fluid in a continuous purge flow mode of the device to a first opening of a chamber and through the chamber to the device outlet prior to and after sampling of the fluid;

a displacer within the chamber, the displacer being in a continuous purge state when the fluid is directed through the chamber in the continuous purge flow mode;

the flow path altering valve being further configured when activated to change the continuous purge flow mode of the device to a sample discharge flow mode in which the fluid is directed to a second opening of the chamber and through the chamber and the displacer is converted from the continuous purge state to a sample discharged state and the volume of fluid already present in the chamber is discharged through the first opening to obtain a sample of the fluid.

Directing the fluid through the chamber in the continuous purge flow mode allows for continuous purging of the chamber with the circulating fluid so that when a sample is taken the fluid is a representative “fresh” sample of fluid.

In some embodiments the device further comprises a pressure reducing valve and a flow limiting valve.

The flow path altering valve may also comprise a solenoid configured for attaining an energized state that changes the continuous purge flow mode to the sample discharge flow mode.

The device may further comprise a non-return valve between the flow path altering valve and the chamber for preventing back flow of the fluid already present within the chamber to the flow path altering valve when the device is in the sample discharge flow mode during sampling of the fluid.

According to some embodiments the chamber is a cylindrical chamber further comprising:

a displacer plug adjacent to the displacer when the displacer is in the continuous purge state; and

a check valve located within the displacer for allowing the fluid to flow through the displacer in the continuous purge flow mode but preventing the fluid from flowing through the displacer in the sample discharge flow mode. The one-way check valve within the displacer helps to ensure a fresh representative sample of fluid will be taken from the chamber.

In some embodiments the displacer is a piston.

The device may also have a sample isolation valve between the chamber and a sample receptacle housing, the sample isolation valve being configured to be closed during the continuous purge flow mode or open during the sample discharge flow mode. When closed, the sample isolation valve prevents fluid present in the chamber from traveling from the chamber to the sample point in the sample receptacle housing during the continuous purge flow mode i.e. before sampling is initiated and after sampling is finished. If a sample isolation valve is present, the sample isolation valve may be a pilot operated check valve. A pilot piston may also be included within the sample isolation valve.

In some embodiments the device comprises a detent valve between the sample isolation valve and the sample receptacle housing. The detent valve prevents more than one sample being deposited into the sample point in the sample receptacle housing until the detent valve is manually reset.

The device may also have a port on a wall of the chamber that is exposed to the interior of the chamber when the displacer is in the sample discharged state, the exposed port allowing a portion of the fluid to flow to, and close, the detent valve. This is known as a position dependent pilot signal.

The detent valve may have a detent button for manually resetting the detent valve after sampling the fluid.

The device may further comprise a sample receptacle for receiving the discharged fluid from the first opening during the sample discharge flow mode. The sample receptacle housing will be suitable for receiving the sample receptacle.

The device may also include a safety bleed valve that is operatively connected to the sample receptacle housing. A filter may also be included between the safety bleed valve and the sample receptacle housing.

A low pressure check valve for allowing air in the sample receptacle to be displaced to the atmosphere during sampling of the fluid may be present in some embodiments. A filter may be fitted in line with the low pressure check valve to prevent ingress of contaminants from the atmosphere into the sample receptacle.

The device may be mounted to the system by at least one bolt included with the device. Preferably, at least two bolts are included with the device.

The present invention in a second form resides broadly in a method of sampling a fluid circulating under pressure through a system, the method comprising:

connecting a device as described above to the system;

allowing the fluid to circulate through the device; and

obtaining a sample of the fluid from the device.

The system may be a lubrication circuit of an engine. The fluid may be an oil, coolant, or hydraulic fluid.

Further advantageous embodiments are disclosed below and in the appended patent claims.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic showing the general operation of a device for sampling a fluid according to an embodiment of the invention.

FIG. 2A is a front perspective view of a device for sampling a fluid according to an embodiment of the invention.

FIG. 2B depicts the device in FIG. 2A with the manifold of the device removed to show the remaining components of the device.

FIG. 2C is a rear perspective view of the device in FIG. 2A.

FIG. 2D depicts the device in FIG. 2C with the manifold of the device removed to show the remaining components of the device.

FIG. 3A is a vertical cross-sectional perspective view of the device taken along line A-A in FIG. 2A.

FIG. 3B is a vertical cross-sectional perspective view of the device taken along line B-B in FIG. 2A.

FIG. 3C is a vertical cross-sectional perspective view of the device taken along line C-C in FIG. 2A.

FIG. 3D is a horizontal cross-sectional perspective view of the device taken along line D-D in FIG. 2A.

FIG. 3E is a horizontal cross-sectional perspective view of the device taken along line E-E in FIG. 2A.

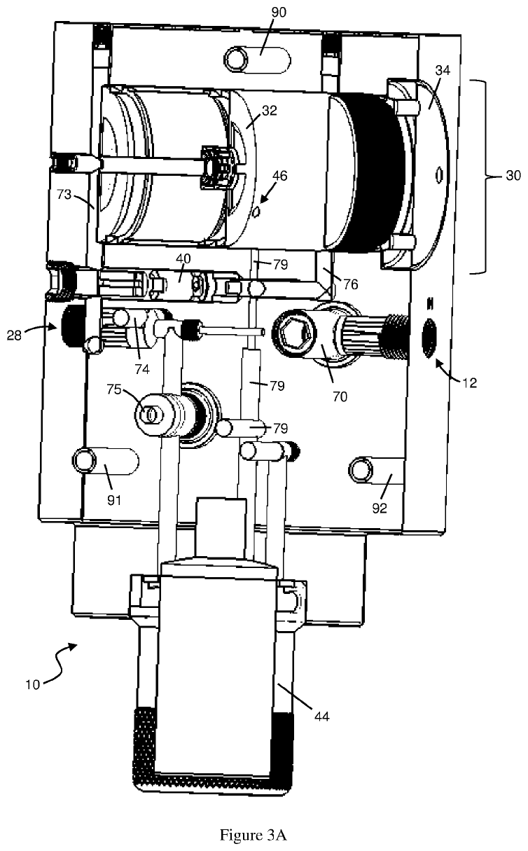

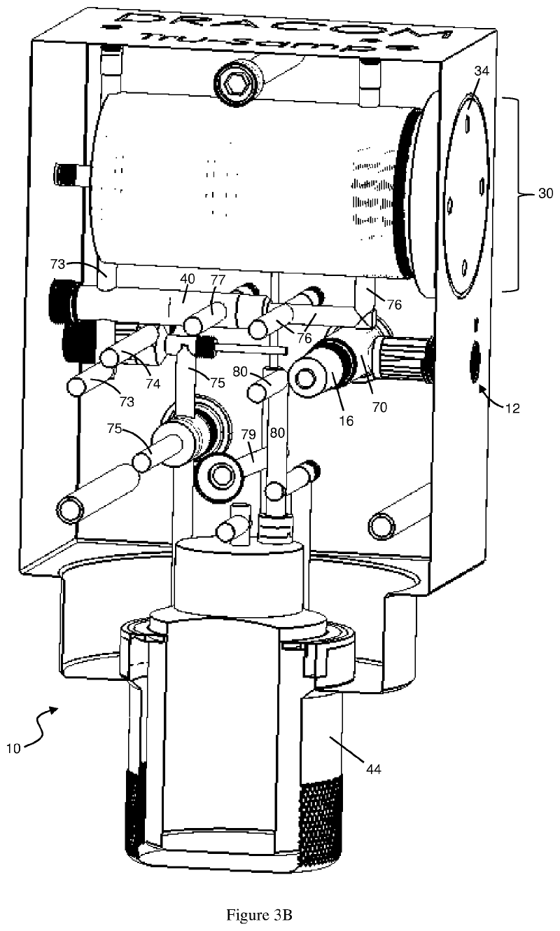

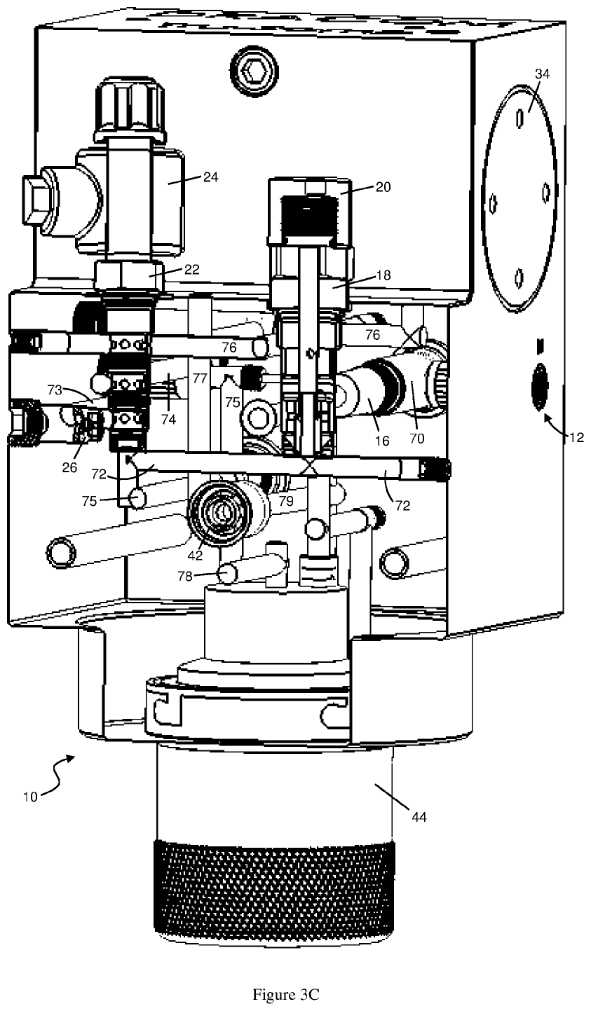

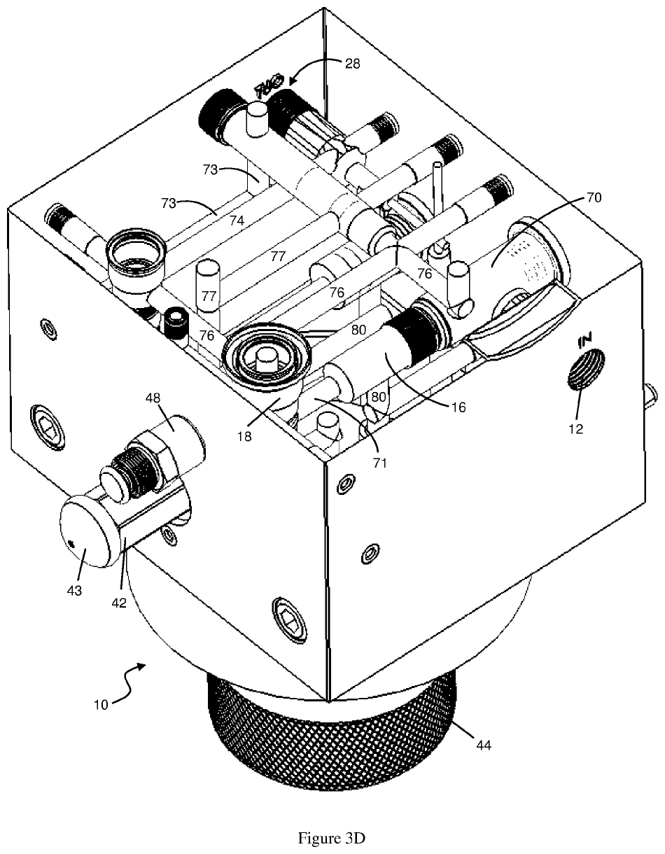

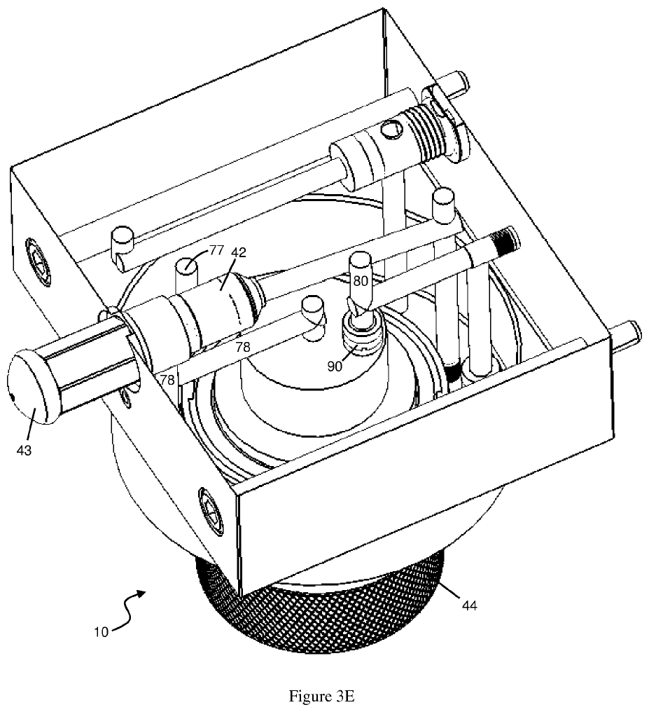

In the cross-sectional views of FIGS. 3A-3E, the manifold of the device is drawn in transparent form in order to better show the galleries and other components of the device associated with the manifold.

### DETAILED DESCRIPTION

The components of the fluid sampler device 10 as depicted in the accompanying figures and their respective reference numeral(s) are listed in the table below.

| Component | Reference Numeral(s) |
|---|---|
| Fluid sampler device | 10 |
| Device inlet | 12 |
| Manifold | 14 |
| Flow limiting valve | 16 |
| Pressure reducing valve | 18 |
| Pressure valve cap | 20 |
| Flow path altering valve | 22 |
| Flow path altering valve ports | 22a, 22b, 22c, 22d |
| Solenoid coil | 24 |
| Check valve (non-return valve) | 26 |
| Device outlet | 28 |
| Displacement cylinder chamber | 30 |
| First chamber opening | 30a |
| Second chamber opening | 30b |
| Displacer | 32 |
| Position of the displacer in the continuous | 32a |
| purge state | |
| Position of the displacer in the sample | 32b |
| discharged state | |
| Displacer plug | 34 |
| Check valve | 36 |
| Pilot operated check valve | 40 |
| Detent valve | 42 |
| Detent button | 43 |
| Sample receptacle housing | 44 |
| Pilot port | 46 |
| Safety bleed valve | 48 |
| Filter | 50 |
| Expander Plugs | 52, 53, 54, 55, 56, |
| | 57, 58, 59, 60, 61, 62, |
| | 63, 64, 65, 66, 67 |
| Galleries | 70, 71, 72, 73, 74, 75, |
| | 76, 77, 78, 79, 80 |
| Threaded Plugs | 84, 85, 86, 87 |
| Bolts | 90, 91, 92 |
| Check valves | 95, 96 |
| Input signal to commence sampling | 102 |
| Output signal confirming sampling commenced | 104 |
| Signal confirming full discharge of sample | 106 |
| from the displacement cylinder chamber | |

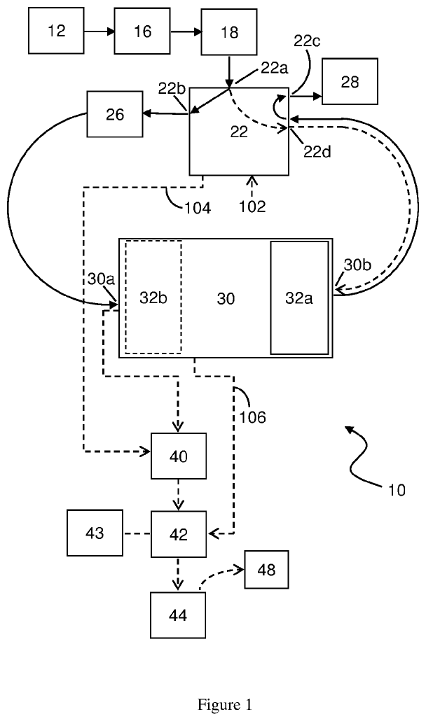

FIG. 1 illustrates the general operation of a device 10 for sampling fluids according to one embodiment of the disclosure. Fluid (not shown) enters device inlet 12 and passes through flow limiting valve 16 to pressure reducing valve 18 as will be described further below. The fluid then leaves valve 18 and enters flow path altering valve port 22a of flow path altering valve 22 which will also be described further below. In the non-sampling mode of the device 10, the fluid passes through valve 22 and exits through flow path altering valve port 22b to the non-return check valve 26. The fluid then travels to and enters displacement cylinder chamber 30 through first chamber opening 30a at one end of the chamber 30. A displacer 32 is present inside chamber 30. Displacer 32 is reversibly moveable between position 32a when the device 10 is in a continuous purge state and position 32b when the device 10 is in a sample discharged state. The fluid entering first chamber opening 30a pushes displacer 32 to position 32a at the other end of opening 30a. The structure and design of the displacer 32, which will be described further below, permits the fluid to flow through the displacer 32 in one direction only and exit chamber 30 through second chamber opening 30b. A pilot operated check valve 40 is closed at this time. The fluid returns to the flow path altering valve 22 entering through flow path altering valve port 22d. Finally, the fluid exits valve 22 through flow path altering valve port 22c to device outlet 28. The above described fluid pathway from flow path altering valve port 22b to device outlet 28 as shown by the solid arrows in FIG. 1 occurs when the device is operating in a continuous purge flow mode (i.e. the non-sampling mode). This mode allows for continuous purging of chamber 30 with the circulating fluid so that when a sample is taken the fluid is a representative sample of the fluid. When a sample of the fluid is required, an input signal 102 is sent to flow path altering valve 22. Flow path altering valve 22 then changes the path of the fluid flow from valve port 22a to valve port 22d as shown by the dashed arrow in FIG. 1. At the same time, an output signal 104 is sent to the pilot operated check valve 40 to open valve 40. Output signal 104 may be in the form of the redirected fluid pressure acting on a pilot piston of the valve 40. The fluid is sent back to and enters chamber 30 through second chamber opening 30b. The fluid pushes displacer 32 from position 32a to position 32b at the other end of chamber 30. As a result, the fluid that was already present in chamber 30 is displaced from the chamber through first chamber opening 30a and the now open pilot operated check valve 40. The displaced fluid cannot go back through one-way valve 26 to valve 22. The displaced fluid passes through detent valve 42 into a sample receptacle in sample receptacle housing 44. When the displaced fluid is fully discharged from chamber 30, a signal 106 is sent to detent valve 42 to close the detent valve 42. Signal 106 may be in the form of a separate fluid flowing from chamber 30 to detent valve 42 as will be described further below in respect of pilot port 46. When detent valve 42 is closed no further fluid can enter the sample bottle until detent button 43 is pressed. The fluid sampling pathway from flow path altering valve port 22d to the sample bottle as shown by the dashed arrows in FIG. 1 occurs when the device is operating in a sample discharge flow mode (i.e. the sampling mode). After a pre-determined time period which corresponds to when the detent valve 42 closes, the flow path altering valve 22 changes the path of the fluid flow back to the pathway of the continuous purge flow mode as described above and as shown by the solid arrows in FIG. 1. A safety bleed valve 48 is operatively connected to the housing 44 as a safety measure although the fluid in the sample receptacle is not normally under pressure.

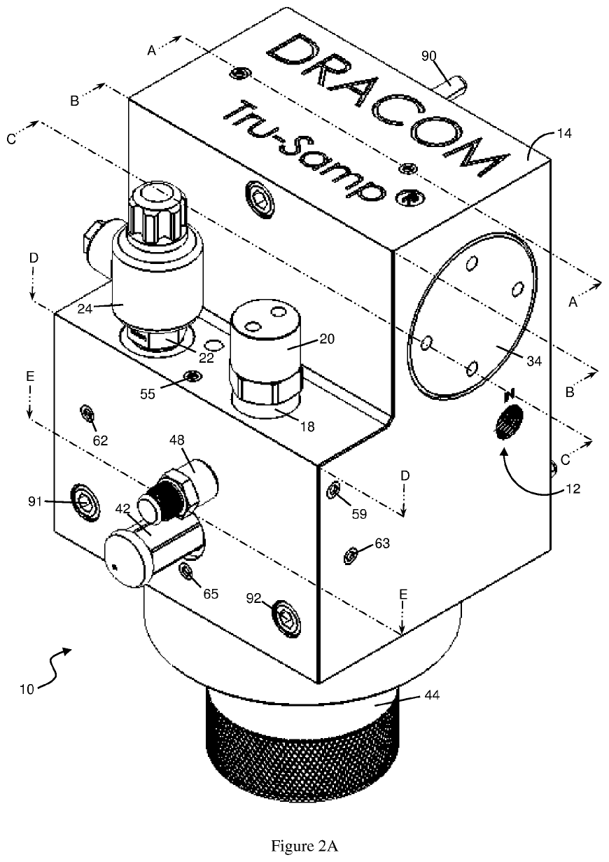

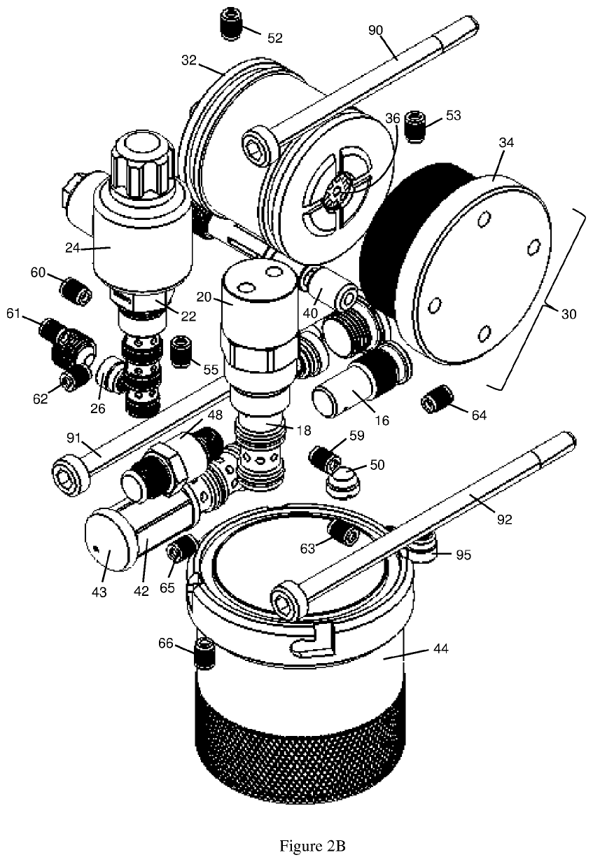

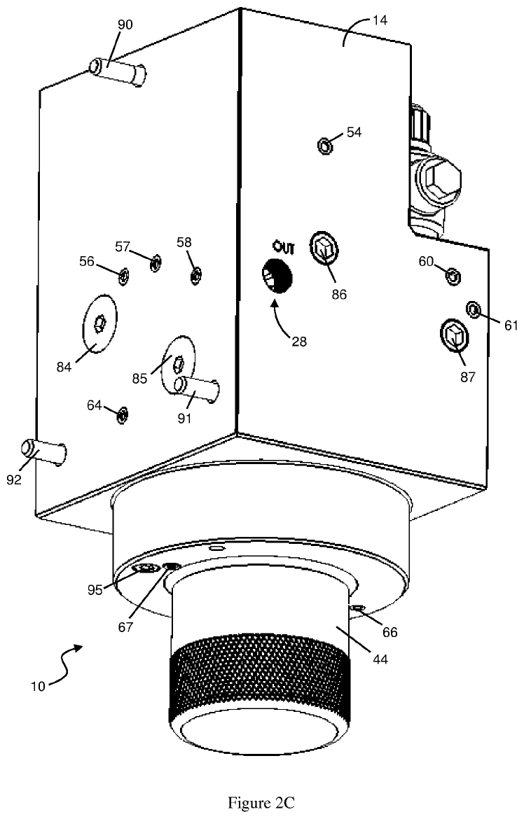

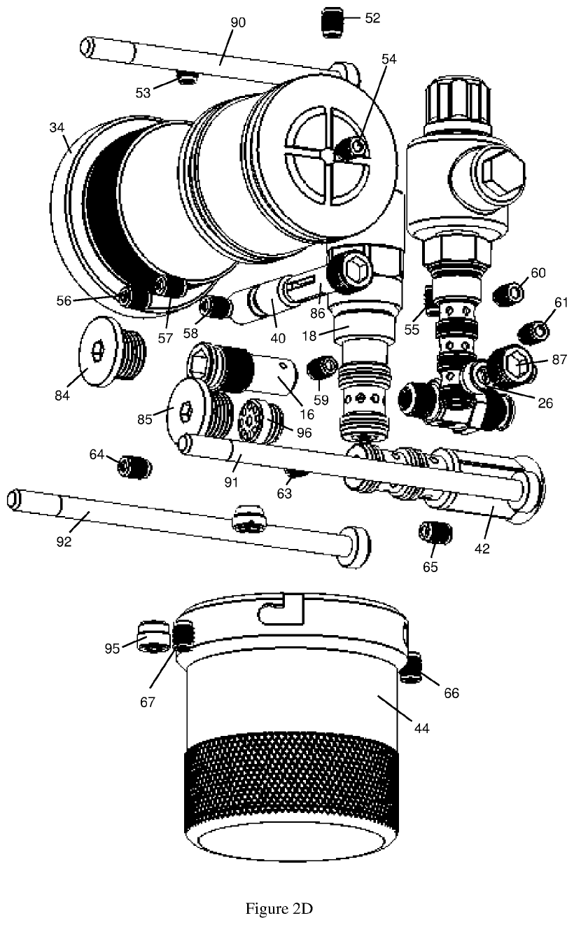

FIGS. 2A and 2C illustrate the device 10 in FIG. 1 in more detail. Device 10 has a manifold 14 made of metal such as aluminium. Inlet 12, outlet 28, pilot port 46, and galleries 70-80 are drilled or machined into manifold 14 using known techniques. The remaining components listed in the table above are readily obtained from known commercial sources then fitted to manifold 14 to form the assembled device 10. Expander plugs 52-67 and threaded plugs 84-87 are used to close the holes in manifold 14 created during drilling and machining. Check valves 95, 96 prevent backflow of fluid or contaminants into the device 10. Bolts 90-92 are provided for mounting the device 10 onto a wall or other suitable fixture.

The device 10 is suitable for connecting to a system with a circulating fluid requiring periodic sampling and monitoring of the fluid for quality control or assurance purposes. The device 10 is integrated into a number of fixed or mobile machinery fluid systems or circuits where fluid analysis is required. The device 10 is connected in parallel i.e. only part of the circulating fluid passes through device 10. Operation of the device 10 may be automated wherein activation of the device to take a fluid sample at a pre-determined time during the operation of the machinery is controlled by a Programmable Logic Controller (PLC) or similar unit. Alternatively, the device 10 may be manually operated.

The system and fluid are not intended to be particularly limited. For example, the system may be a lubrication circuit of a large diesel engine found on a vehicle such as a truck or ship. The device 10 may be used with other hydraulic systems, fluid circuits, and machines or installations that use fluids such as machines used to form food packages and food filling machines. The fluid may be any type of oil or coolant circulating in a machine, car, truck, or ship. The fluid may often be circulating at high pressure through the system. For example, if the system is a lubrication circuit of an engine and the fluid is engine oil, then the oil may be circulating between about 80 to 90 psi. Alternatively, if the fluid is a coolant then the coolant may be circulating at a pressure between about 10 to 60 psi. In any case, the device 10 is able to withstand fluid that is circulating at a pressure up to about 3000 psi.

A more detailed method for sampling a fluid using device 10 will now be described.

The fluid (not shown) in the system or vehicle to which the device 10 is connected to enters the device 10 via the device inlet 12 of the manifold 14 as shown in FIG. 2A and passes immediately through a gallery 70 in the manifold 14 to a flow limiting valve 16 that is pressure compensated, non-adjustable, and is pre-set to a minimal flow rate. This may be seen in the FIGS. 3A-3C. The valve 16 is shown in full in FIGS. 2B and 2D.

The fluid then passes through gallery 71 in the manifold 14 to a pressure reducing valve 18 to reduce the pressure experienced by the remaining components within the device 10. A pressure valve cap 20 is present on top of the pressure reducing valve 18 as shown in FIGS. 2A and 2B.

The flow limiting valve 16 and/or the pressure reducing valve 18 reduce the pressure and flow rate of the fluid as soon as the fluid enters the device 10. The flow limiting valve 16 results in a reduction of the hazard associated with un-controlled high-flow fluid release. The pressure reducing valve 18 allows for a significant reduction of the pressures within other areas of the device 10 after valve 18 including the sample bottle as will be described below. Valve 18 also mitigates pressure hazards.

After the fluid passes through the pressure reducing valve 18, it is directed through gallery 72 to a flow path altering valve 22 shown in FIGS. 2A, 2B, and 3C. A solenoid coil 24 is operatively associated with flow path altering valve 22. The solenoid coil 24 remains in a de-energised state and a spring offset position other than when a fluid sample is being taken for analysis purposes as will be described below. The valve 22 controls the direction of fluid flow in and out of the metering chamber which is described below as displacement cylinder chamber 30.

In the de-energised state, the fluid passes out of valve 22 and through a 0.2 bar check valve 26 located adjacent to flow path altering valve 22 as shown in FIGS. 2B and 3C. The purpose of the check valve 26 is to prevent reverse flow of fluid during the sampling mode described below. After valve 26, the fluid passes into gallery 73 which extends towards the back of the device 10 then up and adjacent to a displacement cylinder chamber 30 towards the top of the device 10. This is best shown in FIGS. 3A-3C. The fluid flows through gallery 73 and enters the displacement cylinder chamber 30 through a first chamber opening. Thus, the check valve 26 is a low pressure, one-way or non-return valve placed between the flow path altering valve 22 and the chamber 30 to ensure the fluid can only flow one-way from the flow path altering valve 22 to the chamber 30.

The displacement cylinder chamber 30 provides a measured volume of fluid to suit the nominated sampling bottle (not shown) thereby preventing overfilling and possible fluid spill during removal of the sample bottle by the user. The displacement cylinder chamber 30 comprises a displacer 32, a displacer plug 34, and a check valve 36 located coaxially with, and in, the displacer 32. The components of chamber 30 are best shown in FIG. 2B. One example of a displacer 32 is a piston. The displacer plug 34 may be a piston plug.

The fluid entering the displacement cylinder 30 from gallery 73 forces the displacer 32 from its position depicted in FIG. 2B towards displacer plug 34 until displacer 32 abuts plug 34. As the pressure rises within the displacement cylinder 30, fluid flows over the check valve 36 within the displacer 32 and through gallery 76 leading away from the lower side of the cylinder 30 as shown in FIG. 3A. The fluid continues to pass through gallery 76 back to the solenoid-operated flow path altering valve 22 as seen in FIGS. 3B and 3C before passing to the device outlet 28. Thus, the chamber 30 has a bypass functionality that allows continuous purging of the chamber 30 with fluid from the fill end adjacent to gallery 73 and discharging out the opposing end of the chamber 30 through gallery 76. The check valve 36 in the bypass passage ensures one way flow of purging fluid through the chamber 30 to displace any residual contaminating fluids. This continual flow or cycling of fluid ensures that when the fluid sample for testing is taken it is based on the current fluid condition i.e. it is a representative sample or “live sample”.

At this purging stage, the fluid is isolated from the fluid sample bottle due to a pilot operated check valve 40 being in a closed position. The pilot operated check valve 40 is shown fully in FIG. 2D and partially in FIGS. 2B and 3A.

When it is time for a fluid sample to be taken for testing, the user activates a control unit (not shown) to energise the solenoid coil 24. This reverses the fluid flow path described above.

As the solenoid coil is no longer in its de-energised state, the fluid is redirected back through gallery 76 to the lower side of the cylinder 30 and into the cylinder 30 near the displacer plug 34. As described above, the check valve 36 only permits the fluid to flow one way towards the displacer plug 34 and gallery 76. Valve 36 does not permit the fluid to flow back to gallery 73. Hence, the redirected fluid causes the displacer 32 to move away from the plug 34 towards the position shown in FIGS. 2B and 3A.

The pilot operated check valve 40 is opened during this phase to allow the predetermined or fixed fluid volume displaced from cylinder 30 to pass through valve 40 and towards the sample bottle. The volume of fluid displaced from the cylinder 30 is less than the volume of the sample bottle. The redirected fluid pressure acts on a pilot piston (not shown) of the pilot operated check valve 40. The pilot operated check valve 40 and pilot piston have a 3:1 ratio meaning the pilot piston will open the valve 40 when experiencing a pressure that is one third of the pressure up stream of the valve 40.

The displacer 32 moves away from plug 34 to displace a measured fluid volume from the displacement cylinder 30. Thus, the measured fluid volume flows back and down through gallery 73 to and over an open check valve (not shown) within the pilot operated check valve 40. See FIG. 3A. The fluid volume continues to flow through gallery 77 which extends towards the front of device 10 then downwardly to a detent valve 42 as shown in FIGS. 3B-3E. Detent valve 42 is positioned between the pilot operated check valve 40 and the sample bottle. The fluid volume enters an opening of detent valve 42. The detent valve 42 is a manual reset detent valve but could also be an auto reset detent valve. The fluid passes through detent valve 42 and exits into gallery 78 that leads into the sample bottle or sample receptacle located in the sample receptacle housing 44 at the bottom of the device. Gallery 78 is best seen in FIGS. 3C and 3E.

Air in the sample bottle is displaced to the atmosphere through low pressure check valve 95 to prevent reverse ingress of contaminants into the sample receptacle housing 44 and sample bottle.

The measured or pre-determined fluid volume is selected to match the desired volume of the sample bottle thereby avoiding overfilling of the sample bottle and eliminating spillage of the fluid. The desired volume is attained by adjustment of displacer plug 34.

When the displacer 32 has moved a certain distance away from plug 34, a seal on the peripheral surface of the displacer 32 uncovers a pilot port 46 in the wall of the cylinder 30 shown in FIG. 3A thereby allowing the fluid to flow into the pilot port 46 and then via gallery 79 in the manifold 14 to connect to the pilot section of the manual detent valve 42. Adequate back pressure is generated in gallery 79 to close the detent valve 42 and prevent any further fluid entering the sample bottle. This also disables the device 10 from allowing a second sample to be taken until the sample bottle is removed and a replacement bottle is installed, at which time the detent valve 42 is manually reset to the open position by pressing detent button 43. Again, this helps to avoid overfilling/multiple filling of the sample bottle and eliminate spillage of the fluid. In an alternative embodiment to a manual reset button, the fitting of a new sample bottle resets the detent valve 42.

The solenoid coil is energised for a pre-determined time period corresponding to the time taken for the displacer 32 to move from its position in contact with the plug 34 to the position where the pilot port 46 is uncovered. Upon completion of the programmed time period during which the solenoid is energised, the solenoid in the flow path altering valve 22 returns to its de-energised state. The fluid flow reverts to the flow described above i.e. fluid passes out of valve 22, through the check valve 26 and gallery 73, and enters the displacement cylinder chamber 30. The displacer 32 resets to its position abutting plug 34 in readiness for the next sampling event. The pilot operated check valve 40 closes due to the pressure on the pilot piston of valve 40 being relieved. In an alternative embodiment to a timer and the pre-determined time period, the flow of fluid through the pilot port 46 resets valve 22 to its de-energised state.

The relative pressure of the fluid within the sampling bottle cavity is limited to 0.02 bar by an inbuilt safety bleed valve 48 that is operatively connected to the sample receptacle housing 44 via gallery 80 in the manifold 14. This is best viewed in FIGS. 3D and 3E. A filter 50 is present between gallery 80 and the sampling bottle cavity. The filter 50 functions as a screen to keep insects from nesting in the drilling or vent drilling when the device is used in a mining operation. If necessary, the safety bleed valve 48 relieves the pressure directly to the atmosphere.

The device 10 allows for safely taking a live fluid sample from a hydraulic system, fluid circuit or other machines or installations that use fluids. The device 10 is suitable for use with hydraulic systems operating at high pressure (up to 3000 psi). The device 10 reduces the risk of fluid exposure to the user and the environment.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A device for sampling a fluid circulating through a system, the device comprising:
a device inlet through which the fluid enters the device under pressure, and a device outlet;
a pressure reducing and/or flow limiting valve or valves between the device inlet and the device outlet for reducing the pressure and/or limiting the flow of the fluid after the fluid enters the device;
a flow path altering valve between the pressure reducing and/or flow limiting valve(s) and the device outlet, the flow path altering valve being configured for receiving the fluid from the pressure reducing and/or flow limiting valve(s) and directing the fluid in a continuous purge flow mode of the device to a first opening of a chamber and through the chamber to the device outlet prior to and after sampling of the fluid;
a displacer within the chamber, the displacer being in a continuous purge state when the fluid is directed through the chamber in the continuous purge flow mode;
the flow path altering valve being further configured when activated to change the continuous purge flow mode of the device to a sample discharge flow mode in which the fluid is directed to a second opening of the chamber and through the chamber and the displacer is converted from the continuous purge state to a sample discharged state and the volume of fluid already present in the chamber is discharged through the first opening to obtain a sample of the fluid.

2. The device of claim 1, comprising a pressure reducing valve and a flow limiting valve.

3. The device of claim 1, wherein the flow path altering valve comprises a solenoid configured for attaining an energized state that changes the continuous purge flow mode to the sample discharge flow mode.

4. The device of claim 1, further comprising a non-return valve between the flow path altering valve and the chamber for preventing back flow of the fluid already present within the chamber to the flow path altering valve when the device is in the sample discharge flow mode during sampling of the fluid.

5. The device of claim 1, wherein the chamber is a cylindrical chamber further comprising:
a displacer plug adjacent to the displacer when the displacer is in the continuous purge state; and
a check valve located within the displacer for allowing the fluid to flow through the displacer in the continuous purge flow mode but preventing the fluid from flowing through the displacer in the sample discharge flow mode.

6. The device of claim 1, wherein the displacer is a piston.

7. The device of claim 1, further comprising a sample isolation valve between the chamber and a sample receptacle housing, the sample isolation valve being configured to be closed during the continuous purge flow mode or open during the sample discharge flow mode.

8. The device of claim 7, wherein the sample isolation valve is a pilot operated check valve.

9. The device of claim 7, further comprising a pilot piston within the sample isolation valve.

10. The device of claim 1, further comprising a detent valve between the sample isolation valve and the sample receptacle housing.

11. The device of claim 10, further comprising a port on a wall of the chamber that is exposed to the interior of the chamber when the displacer is in the sample discharged state, the exposed port allowing a portion of the fluid to flow to, and close, the detent valve.

12. The device of claim 10, wherein the detent valve further comprises a detent button for manually resetting the detent valve after sampling the fluid.

13. The device of claim 1, further comprising a sample receptacle for receiving the discharged fluid from the first opening during the sample discharge flow mode.

14. The device of claim 7, further comprising a safety bleed valve that is operatively connected to the sample receptacle housing.

15. The device of claim 14, further comprising a filter between the safety bleed valve and the sample receptacle housing.

16. The device of claim 13, further comprising a low pressure check valve for allowing air in the sample receptacle to be displaced to the atmosphere during sampling of the fluid.

17. The device of claim 1, further comprising at least one bolt for mounting the device to the system.

18. A method of sampling a fluid circulating under pressure through a system, the method comprising:
connecting a device according to claim 1 to the system;
allowing the fluid to circulate through the device; and
obtaining a sample of the fluid from the device.

19. The method of claim 18, wherein the system is a lubrication circuit of an engine.

20. The method of claim 18, wherein the fluid is selected from an oil, a coolant, or a hydraulic fluid.
